(19) United States
(12) Patent Application Publication
(10) Pub. No.: US 2010/0083329 A1
(43) Pub. Date: Apr. 1, 2010

(54) APPARATUS, METHOD AND SYSTEM FOR SELECTING AND CONFIGURING INTERNET CONTENT FOR BYPASS ENCAPSULATION WITHIN A BYPASS ARCHITECTURE

(75) Inventors: Gerald R. Joyce, Newton, MA (US); Qi Bao, Westborough, MA (US); David Flanagan, Framingham, MA (US); Michael W. Patrick, Assonet, MA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 12/241,184

(22) Filed: Sep. 30, 2008

(51) Int. Cl. H04N 7/173

(52) U.S. Cl. 725/110

(57) ABSTRACT

An apparatus, method and system for delivering Internet content within a system that includes an encapsulation database and a last-hop router as part of a bypass architecture, such as a bypass architecture that transmits IP content from a source to a downstream modulator, such as an EQAM modulator, in a manner that bypasses the system's Cable Modem Termination System (CMTS). The encapsulation database, which typically is controlled by the MSO, but also is in operable communication with the last-hop router and CMTS, is configured to store encapsulation identification information, which is used to identify which portions of the IP content receive bypass encapsulation. The encapsulation database also can include the QoS settings for such identified portions of IP content. The encapsulation database allows the MSO to provide QoS settings for select portions of IP content, such as videos from internet video providers with whom the MSO has made special arrangements.

### BACKGROUND OF THE INVENTION

1. Field of the Invention

The invention relates to the delivery of Internet Protocol (IP) content over cable systems using a standard protocol Data Over Cable System Interface Specification (DOCSIS). More particularly, the invention relates to transmitting IP content within systems involving Cable Modem Termination System (CMTS) architecture and processing.

2. Description of the Related Art

Most cable systems currently provide video (and data) content delivery services via digital broadcast. The video image is first digitized, and then compressed, e.g., via one of several digital algorithms or compression standards, such as the MPEG2 (Moving Pictures Expert Group) algorithm or the MPEG4 part 10 algorithm, where the latter also is known as the International Telecommunications Union (ITU) H.264 standard. These compression standards allow the same video content to be represented with fewer data bits. Using MPEG2, standard definition television currently can be transmitted at a rate of approximately 4 Megabits per second (Mbps). Using MPEG 4 Part 10, the same video content can be transmitted at a rate of approximately 2 Mbps. The digital video content typically is transmitted from a source at a cable provider's headend to one or more network elements, such as an end user's set-top box (or other suitable video processing device), via a digitally modulated radio frequency (RF) carrier, with the video content organized into an MPEG2 Transport Stream (MPEG2-TS) format.

Cable system operators are considering Internet Protocol (IP)-based methods for delivery of content, such as IP-video and IP Television (IPTV), to supplement their current digital video delivery methods. The internet protocol is not required for MPEG2 Transport Streams. However, IP-based video delivery allows the possibility of new video sources, such as the Internet, and new video destinations, such as end user IPTV playback devices. If cable systems do include IP-based content delivery, it is quite possible and likely that relatively large amounts of bandwidth will be needed to deliver IPTV content to end users. Moreover, as end users continue to shift their viewing desires toward on-demand applications, a relatively large percentage of such on-demand content likely will be IPTV content.

The cable industry developed the Data Over Cable System Interface Specification (DOCSIS®) standard or protocol to enable the delivery of IP data packets over cable systems. Later, in anticipation of IP video traffic, the DOCSIS 3.0 standard was developed. In general, DOCSIS defines interface requirements for cable modems involved in high-speed data distribution over cable television system networks. The cable industry also developed the Cable Modem Termination System (CMTS) architecture and the Modular CMTS (M-CMTS™) architecture for this purpose. In general, a CMTS is a component, typically located at the headend or local office of a cable television company, that exchanges digital signals with cable modems on a cable network.

In general, an EdgeQAM (EQAM) or EQAM modulator is a headend or hub device that receives packets of digital content, such as video or data, re-packetizes the digital content into an MPEG transport stream, and digitally modulates the digital transport stream onto a downstream RF carrier using Quadrature Amplitude Modulation (QAM). EdgeQAMs are used for both digital broadcast, and DOCSIS downstream transmission. In a conventional IPTV network system arrangement using M-CMTS architecture, the EdgeQAMs are downstream DOCSIS modulators, and are separated from a core portion of the M-CMTS core. An IPTV server or other suitable IP content provider is coupled to a regional area or backbone network. This backbone network, in turn, is connected to a converged interconnect network (CIN) which also links the M-CMTS core and the EdgeQAMs. The CIN performs as one or more access routers or switches, i.e., devices configured for routing data in an IP network. There is a Layer Two Tunneling Protocol version 3 (L2TPv3) tunnel from the M-CMTS core to the EdgeQAMs, with this tunnel being identified as a DOCSIS External Physical Interface (DEPI). The IPTV content is carried on the downstream DOCSIS RF carrier from the EdgeQAM to one or more end user network elements, such as a DOCSIS set-top box or an Internet Protocol set-top box (IP-STB). An IP set-top box is a set-top box or other multimedia content processing device that can use a broadband data network to connect to television channels, video streams and other multimedia content. An upstream DOCSIS receiver is coupled to and receives data from a cable modem via the DOCSIS protocol. Some of the data is simply DOCSIS Media Access Control (MAC) Management packets originating at the cable modem (CM) and used for the functioning of the DOCSIS protocol. Other data are upstream IP packets from devices connected to the CM, such as on-demand commands, from the end user multimedia content processing device, and are forwarded to other devices via the CIN. Upstream DOCSIS receivers are combined with or contained within a core portion of the M-CMTS component.

In general, for conventional M-CMTS architecture, all packets traveling upstream or downstream typically travel through the M-CMTS core for appropriate forwarding to the correct network interface or DOCSIS carrier. However, since the downstream DOCSIS modulators (i.e., the EQAMs) are separate from the M-CMTS core, the downstream packets travel from the M-CMTS core, through the CIN, and to the EQAMs on special “tunnel” or “pseudo-wire” connections. These tunnels, which are defined by the Layer Two Tunneling Protocol (L2TP) version 3 (i.e., L2TPv3), are known within the DOCSIS 3.0 standard as DOCSIS External Physical Interface (DEPI) tunnels, and typically are carried over gigabit Ethernet links.

One of the features of the DOCSIS 3.0 specification intended to facilitate the use of IPTV content delivery is that the number of downstream EQAMs can be increased independently of the number of upstream DOCSIS data channels. Hence, the downstream DOCSIS capacity can be arbitrarily increased to whatever bandwidth is needed. However, as discussed, downstream IPTV content or data packet flow from the IPTV server to the end user DOCSIS network elements conventionally is required to travel through the CIN to the M-CMTS core, then from the M-CMTS core, on a DEPI tunnel, back through the CIN again, and on to the EQAM. Such “hairpin” forwarding of downstream data packets back through the CIN requires a disproportionate amount of switching bandwidth and other resources compared to other portions of the system.

Accordingly, there has been a need to provide a bypass architecture that overcomes or avoids the issues involved with data packet flow from the CIN into and through the M-CMTS core, and then back from the M-CMTS core through the CIN and on to the EQAM. One application for such a bypass architecture might involve or include direct tunneling of video content from servers controlled by a multiple systems operator (MSO) to a downstream modulator, such as a low-cost downstream EQAM, in a manner that bypasses the CMTS, including the M-CMTS core. In such case the MSO has some latitude in carrying out the DOCSIS M-CMTS core bypass. The necessary encapsulation could be done at the server itself, or at the EQAM, or elsewhere.

However, another application is to provide a bypass to the M-CMTS core for video content that the MSO does not control. This content would not originate from an MSO controlled server, but rather, directly from the Internet. Such content is referred to as over-the-top content, because the IP content bypasses the conventional distribution services of an MSO (or other broadband provider) and goes directly to the end user via an end user network, such as a Hybrid Fiber Coaxial (HFC) network. Over-the-top IP content is expected to comprises a relatively significant portion of all DOCSIS IP content traffic in the future. One application for providing such bypass flows might involve using a last-hop router to transmit over-the-top content received from an IP content source directly to the system EQAM, bypassing the system CMTS. The last-hop router can be configured to allow for proper bypass flow of the IP content to the EQAM. One or both of the last-hop router and the EQAM can be configured to perform the necessary bypass encapsulation of the IP content identified for bypass flow from the last-hop router to the EQAM. The bypass encapsulated content can be transmitted from the EQAM to the end user network elements as a DOCSIS flow.

However, there still is a need to provide a suitable means for selecting which portions of the IP content to receive the necessary bypass encapsulation, and what the appropriate Quality of Service (QoS) settings should be for the IP content selected for bypass encapsulation.

### BRIEF DESCRIPTION OF THE DRAWINGS

FIG. 1 is a block diagram of a conventional Internet Protocol (IP) content delivery system, including a conventional modular Cable Modem Termination System (M-CMTS) network;

FIG. 2 is a block diagram of an IP content delivery system, including a DOCSIS IP-video Bypass Architecture (DIBA), in which the IP content bypasses the M-CMTS core;

FIG. 3 is a block diagram of an IP content delivery system with an integrated CMTS network, and also including a DOCSIS IP-video Bypass Architecture (DIBA), in which the IP content bypasses the integrated CMTS;

FIG. 4 is a block diagram of an IP content delivery system according to the PacketCable Multimedia (PCMM) architecture specifications, including a bypass architecture for over-the-top content, and including an encapsulation database, such as a DIBA Encapsulation Database; and

FIG. 5 is a flow chart that schematically illustrates a method for delivering IP content within a system that includes a bypass architecture for over-the-top content, and that includes an encapsulation database, such as a DIBA Encapsulation Database.

### DETAILED DESCRIPTION

In the following description, like reference numerals indicate like components to enhance the understanding of the bypass architecture and corresponding data encapsulation and transmission devices and methods through the description of the drawings. Also, although specific features, configurations and arrangements are discussed herein below, it should be understood that such specificity is for illustrative purposes only. A person skilled in the relevant art will recognize that other steps, configurations and arrangements are useful without departing from the spirit and scope of the invention.

The apparatus, methods and systems described herein involve using an encapsulation database within an IP content distribution system that includes a last-hop router as part of a bypass architecture within the distribution system. The last-hop router transmits over-the-top content received from an IP content source directly to the system EQAM, bypassing the system CMTS. The bypass encapsulated content is transmitted from the EQAM to the end user network elements as a DOCSIS flow. The encapsulation database, which typically is controlled by the MSO, but also is in operable communication with the last-hop router and the CMTS, is configured to receive, store and make available encapsulation identification information, which is used to identify which portions of the IP content receive bypass encapsulation. The encapsulation identification information also can include the QoS settings for such identified portions of IP content. The encapsulation database allows the MSO to provide QoS settings for select portions of IP content, such as videos from internet video providers with whom the MSO has made special arrangements.

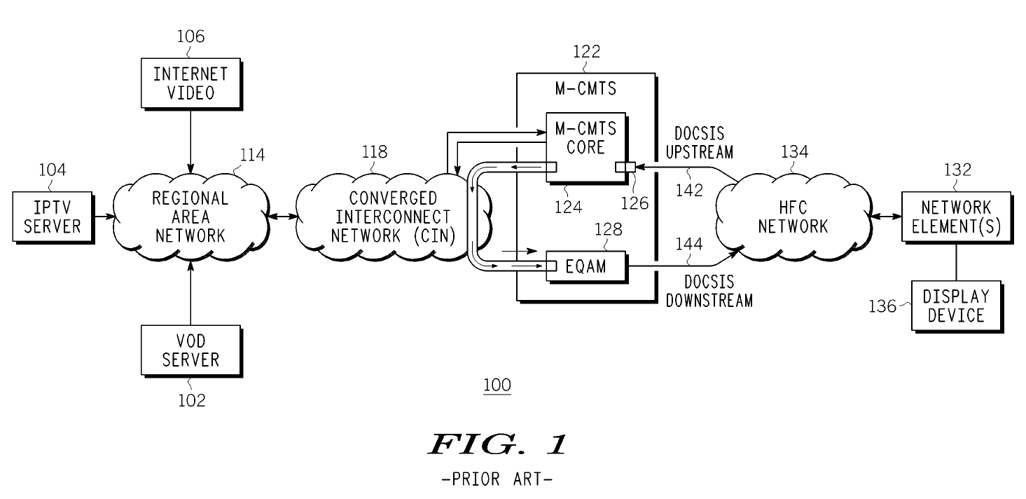

Referring now to FIG. 1, shown is a block diagram of a conventional Internet Protocol (IP) content delivery system 100 including a conventional modular Cable Modem Termination System (M-CMTS) network arrangement. The system 100 includes one or more sources of IP content, e.g., one or more video on demand (VOD) servers 102, IPTV broadcast video servers 104, Internet video sources 106, or other suitable sources for providing IP content. The IP content sources are connected to a regional area or backbone network 114. The regional area network 114 can be any communication network or network server arrangement suitable for transmitting IP content. For example, the regional area network 114 can be or include the Internet or an IP-based network, a computer network, a web-based network or other suitable wired or wireless network or network system.

Coupled to the regional area network 114 is a converged interconnect network (CIN) 118, which includes the routing and switching capability for connecting the regional area network 114 to a Cable Modem Termination System (CMTS), such as a modular CMTS (M-CMTS) 122. In general, as discussed hereinabove, the CIN typically performs as an access router for routing data in an IP network. The CIN typically has gigabit Ethernet interfaces and can perform layer 2/3/4 forwarding, i.e., routing of data in layers 2, 3 and 4 as defined according to the seven-layer Open Systems Interconnection (OSI) network protocol. In general, a CMTS or an M-CMTS is a component that exchanges digital signals with network elements (such as network elements including cable modems, set-top boxes and other content processing devices, and media terminal adapters) on a cable network. The CMTS or M-CMTS typically is located at the local office of a cable television company. In a typical arrangement, the CMTS and the cable modem are the endpoints of the DOCSIS protocol, with the hybrid fiber coax (HFC) cable plant therebetween. DOCSIS enables IP packets to pass between devices on either side of the link between the CMTS and the cable modem.

The M-CMTS 122 includes an M-CMTS core 124, which typically includes or contains one or more upstream receivers 126, such as an upstream DOCSIS receiver. The M-CMTS 122 also includes one or more downstream DOCSIS modulators, such as one or more EdgeQAMs (EQAMs) 128, which are external to and not part of the M-CMTS core 124. The M-CMTS 122 typically is connected to one or more network elements 132, such as an end user cable modem, a set-top box, a media terminal adapter (MTA) or other suitable end user or customer premises equipment (CPE). Note that there should be a cable modem attached to the HFC network. It is possible for a set-top box or MTA to include a cable modem by which that device attaches to the HFC network. The network elements 132 may include an associated display device 136 coupled thereto. The M-CMTS 122 typically is connected to the network elements 132 via an end user network, which typically is a Hybrid Fiber Coaxial (HFC) cable network 134 and/or other suitable end user network or network system.

The upstream receiver 126 is configured to receive upstream IP/DOCSIS transmissions, such as on-demand commands from an end user set-top box. The upstream data is transmitted to the upstream receiver 126 via the network 134 and an upstream data channel 142 coupled between the network 134 and the upstream receiver 126. The M-CMTS core 124, which includes the upstream receiver 126, removes the upstream DOCSIS encapsulation and Ethernet link header. The remaining Internet Protocol (IP) packets, are then re-encapsulated with Ethernet and sent to an IP router, or other suitable device or component, for transmission across the CIN 118 and the regional area network 114. For downstream data, the M-CMTS core 124 completes the Ethernet encapsulation and a portion of the DOCSIS encapsulation, and sends that payload over a DEPI tunnel to one or more EQAMs 128 or other suitable downstream modulators. These EQAMs then complete the encapsulation of the IP packet data within a DOCSIS formatted transport stream or other suitable digital transport stream and modulate the digital transport stream onto a downstream RF carrier using Quadrature Amplitude Modulation (QAM) to the network elements 132. The downstream data is transmitted from the EQAM 128 to the network elements 132 via the network 134 and a downstream data channel 144 coupled between the EQAM 128 and the network 134.

One or more of the components within the M-CMTS 122, including one or more of the M-CMTS core 124, the upstream receiver 126 and the EQAM 128 can be comprised partially or completely of any suitable structure or arrangement, e.g., one or more integrated circuits. Also, it should be understood that the M-CMTS 122 includes other components, hardware and software (not shown) that are used for the operation of other features and functions of the M-CMTS 122 not specifically described herein. Also, the M-CMTS 122 can be partially or completely configured in the form of hardware circuitry and/or other hardware components within a larger device or group of components. Alternatively, the M-CMTS 122 can be partially or completely configured in the form of software, e.g., as processing instructions and/or one or more sets of logic or computer code. In such configuration, the logic or processing instructions typically are stored in a data storage device (not shown). The data storage device typically is coupled to a processor or controller (not shown). The processor accesses the necessary instructions from the data storage device and executes the instructions or transfers the instructions to the appropriate location within the M-CMTS 122.

A DOCSIS 3.0 cable modem and other network elements are able to receive multiple downstream channels 144. According to the DOCSIS 3.0 standard, there may be “primary” and “non-primary” downstream channels. Of these, one and only one downstream channel will be the “primary” downstream channel of the network elements. The network elements will only receive synchronization time-stamps, which are necessary for upstream operation and which are known as SYNC messages, on its primary downstream channel. Thus, the “primary” channel is also a “synchronized” channel. The network elements also rely on the “primary” channel for the delivery of Mac Domain Descriptor (MDD) messages, which enable the network elements to perform operations including plant topology resolution and initial upstream channel selection. During initialization, the network elements are only required to receive Upstream Bandwidth Allocation Maps (MAPs) and Upstream Channel Descriptors (UCDs) on its “primary” downstream channel.

In systems using M-CMTS architecture, the IP data packets traveling upstream or downstream typically travel through the M-CMTS core 124 for appropriate processing and subsequent forwarding to the correct network interface or data carrier, such as a DOCSIS RF carrier. Since the upstream receiver 126 is combined with the M-CMTS core 124 and its processing, upstream data received by the upstream receiver 126 can be transmitted directly from the upstream receiver 126 to the M-CMTS core 124 and then forwarded appropriately. However, since the downstream modulator (EQAM 128) is not part of the M-CMTS core 124, downstream data received by the M-CMTS 122 from the CIN 118 travels first through the M-CMTS core 124 for appropriate processing and then is directed to the EQAM 128 for appropriate conversion and modulation. Downstream data packets from the M-CMTS core 124 conventionally must travel back through the CIN 118 and then to the EQAM 128 using special “tunnel” or “pseudo-wire” connections, such as downstream or DOCSIS Downstream External Physical Interface (DEPI) tunnels. As discussed hereinabove, such “hairpin” forwarding from the M-CMTS core 124 back through the CIN 118 to the EQAM 128 will require a disproportionate amount of switching bandwidth for the M-CMTS core 124 and the CIN 118.

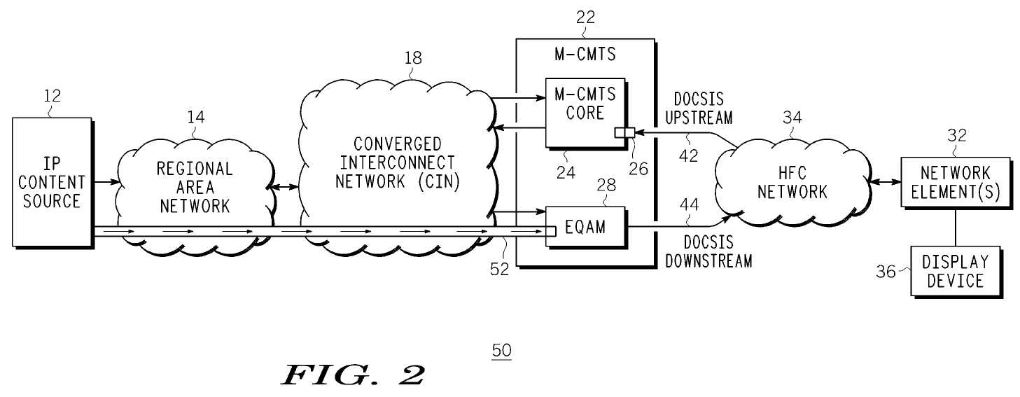

Referring now to FIG. 2, shown is a block diagram of an IP content delivery system 50 including M-CMTS bypass architecture. In the system 50, downstream content or traffic travels directly from one or more IP content sources 12 to an EQAM 28, e.g., via a regional area network 14 and a CIN 18, thus bypassing the M-CMTS core 24. The downstream content travels directly to the EQAM 28 using one or more suitable connections (shown generally as a connection 52). For example, the connection 52 can be one or more “tunnel” or “pseudo-wire” connections, such as a DEPI tunnel. As will be discussed in greater detail hereinbelow, content that is tunneled or otherwise transmitted directly from the IP content source 52 to the EQAM 28 emerges from the EQAM 28 with partial or full DOCSIS framing, suitable for forwarding through to DOCSIS-compatible end user network elements, such as an end user cable modem that is DOCSIS-compatible. In general, the system 50 accomplishes the functionality of an M-CMTS without the associated cost of the M-CMTS core. Conventionally, the M-CMTS does allow the addition of corresponding EQAMs to the system without having to increase the number of upstream data channels, providing some system flexibility. However, the bypass architecture, e.g., as shown in FIG. 2, provides the additional advantage of allowing additional EQAMs, without having to add additional processing capacity to the M-CMTS core 24, or the CIN 18, which would be relatively expensive.

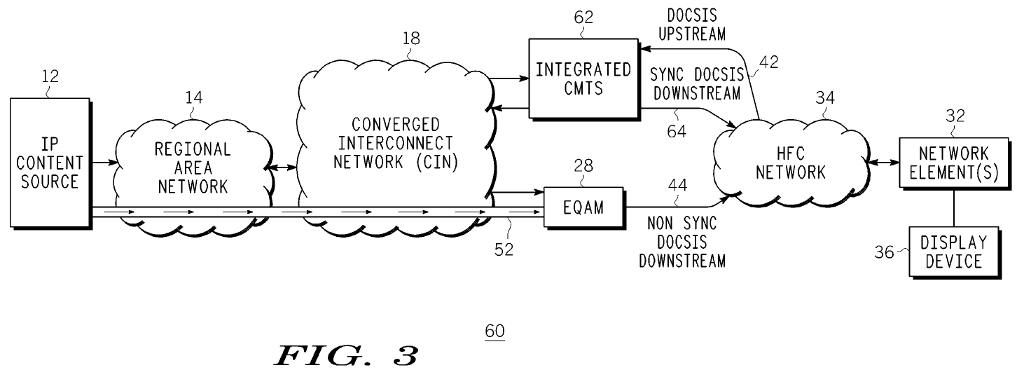

Also, alternatively, an M-CMTS bypass architecture can be used in systems that include an integrated CMTS, rather than a more expensive M-CMTS. In this manner, the bypass architecture makes it possible to deploy an integrated CMTS with additional external EQAMs. The integrated CMTS includes a “synchronized” or “primary” downstream DOCSIS data channel from the integrated CMTS to the end user network elements, in addition to the downstream DOCSIS data channels from the EQAM to the end user network elements, which may be “synchronized” or “non-synchronized.” Referring now to FIG. 3, shown is a block diagram of an IP content delivery system 60 including an integrated CMTS network, and including a bypass architecture in which the IP content bypasses the integrated CMTS. The system 60 includes an integrated CMTS 62, which differs from an M-CMTS in that it also includes a downstream DOCSIS data channel 64 coupled to end user network elements 32, e.g., via an HFC network 34. Network elements 32 can include one or more end user network elements, such as a cable modem, a set-top box, a media terminal adapter (MTA) or other suitable end user or customer premises equipment (CPE). The downstream DOCSIS data channel 64 is fully functional, containing synchronization timestamps, and thus is considered to be “primary” or “synchronized.” By comparison, the downstream DOCSIS data channel 44 from the EQAM 28 to the network elements 32 (via the HFC network 34), which carries IP content, can be configured to operate without synchronization timestamps, and thus may, in that case, be considered to be “non-synchronized.”

Because IP content can be delivered to DOCSIS cable modems and other network elements 32 using non-synchronized downstream data channels, the EQAM 28 can be used to deliver IP content even when the EQAM 28 is not synchronized to the DOCSIS master clock with the DOCSIS Timing Interface (DTI) (not shown), which is part of the integrated CMTS 62. DOCSIS modems require DOCSIS master clock synchronization on only one synchronized data channel, i.e., the so-called “primary” downstream data channel. Therefore, such synchronization can be supplied by the integrated CMTS 62, via the “synchronized” downstream DOCSIS data channel 64. Alternatively, such synchronization can be supplied by a single M-CMTS EQAM that is synchronized to the DOCSIS master clock with the DOCSIS DTI.

By using the CMTS bypass architecture, the system 60 avoids the expense of the CMTS (or the M-CMTS) having to establish or generate both synchronized and non-synchronized downstream data channels for delivery of IP content. A single synchronized data channel from the integrated CMTS 62 or its core can provide the synchronization timestamps, and also provide other DOCSIS Media Access Control (MAC) functions, including instructing the network elements 32 when to transmit upstream and delivering other MAC layer messages for various network element functions, such as registration and maintenance. One or more non-synchronized DOCSIS data channels can be established or generated for one or more EQAMs 28. A non-synchronized DOCSIS data channel generated for an EQAM is less expensive than generating a synchronized DOCSIS data channel for an integrated CMTS or an M-CMTS. Also, with an integrated CMTS and no timestamps in the non-synchronized data channel, the DTI (which is required in the M-CMTS architecture) is not necessary in systems using CMTS bypass architecture.

Depending on the content source 12, the regional area network 14 and the CIN 18, as well as the type of EQAM 28, IP content delivery systems using CMTS bypass architecture can use many different tunneling techniques and therefore have many suitable bypass data encapsulations. Data encapsulation generally is the process of taking a packet of a particular format that contains data as its payload, and enveloping or encapsulating that entire packet as the payload of a new packet. The new packet is generally formed by adding additional header fields, of a different format, to the old packet, which becomes the payload. The outermost header must be compatible with the device receiving the data. If the EQAM 28 is an M-CMTS DEPI EQAM (DEPI EQAM), data encapsulation can occur using at least two DEPI tunneling techniques. Using either tunneling technique, the content source 12 generates or originates an L2TPv3 (DEPI) tunnel to the DEPI EQAM. In the first DEPI tunneling technique, known as the DOCSIS Packet Stream Protocol (PSP), IP content is encapsulated into DOCSIS MAC frames or data packets, i.e., DOCSIS frames are transported in the L2TPv3 tunnel payload (data). In general, the PSP allows DOCSIS frames to be appended together in a queue, using either concatenation (to increase network performance) or fragmentation (if tunneled packets are too large). The PSP DEPI tunneling technique allows the EQAM 28 to mix both IP content originated from the IP content sources 12 with non-IP content, such as VoIP (Voice over Internet Protocol) data originated from the M-CMTS core 24, on the same DOCSIS downstream data carrier.

In the second DEPI tunneling technique, known as DOCSIS MPEG Transport (D-MPT), multiple 188-byte MPEG2 Transport Stream (MPEG-TS) packets are transported in the L2TPv3 tunnel payload. In D-MPT, IP content is encapsulated into DOCSIS MAC frames and the DOCSIS MAC frames are encapsulated into MPEG-TS packets. All DOCSIS frames, including packet-based frames and any necessary MAC management-based frames, are included within the one D-MPT data flow. The EQAM receiving the D-MPT data flow searches the D-MPT payload for any DOCSIS SYNC messages and performs SYNC corrections. The EQAM then forwards the D-MPT packet to the RF interface, for transmission on the RF data carrier. Using the D-MPT tunneling technique, MPEG packets can be received by the EQAM and forwarded directly to the RF interface without having to terminate and regenerate the MPEG framing. The only manipulation of the D-MPT payload is the SYNC correction.

Alternatively, the EQAM 28 can be a standard MPEG2 Transport Stream (MPEG2-TS) EQAM. If the EQAM 28 is an MPEG2-TS EQAM, the IP content source 12 can transmit IP content in PSP formatted data packets. In such case, a PSP/MPT converter is used to convert the data format into an MPEG2-TS format, which an MPEG2-TS EQAM can process. The PSP/MPT converter can be attached to or embedded within the CIN 18 or one or more networking devices within the CIN 18. Alternatively, the IP content source 12 can directly generate and transmit IP content in MPT formatted data packets, which the MPEG2-TS EQAM can process.

As discussed hereinabove, there has been a need to provide a bypass architecture that overcomes or avoids the issues involved with data packet flow from the M-CMTS core back through the CIN and then on to the EQAM. Such a bypass architecture might involve or include direct tunneling of video content from a video server controlled by a multiple systems operator (MSO) to a downstream modulator, such as a low-cost downstream EQAM, in a manner that bypasses the CMTS, including the M-CMTS core. The use of a CMTS bypass or other bypass architecture within an IP content delivery system requires various encapsulation for proper IP content bypass flows. For example, to achieve proper bypass, the IP content servers need to have DOCSIS encapsulation information, as well as selected EQAM information, e.g., tunneling information of the EQAM. In such a bypass architecture, the MSO-controlled server might be modified to perform the DOCSIS encapsulation that conventionally would be done by a CMTS. The MSO-controlled server than would transmit the resulting content with DOCSIS encapsulation to a conventional DOCSIS EQAM via a Downstream External Physical Interface (DEPI) tunnel. The EQAM then transmits the content as a standard downstream DOCSIS RF signal to the end user network and network elements.

However, such systems and methods typically would not apply to over-the-top content, i.e., IP content that originates directly from the Internet, rather than from an MSO-controlled server. As discussed hereinabove, over-the-top content bypasses the conventional distribution services of the MSO-controlled server (or other broadband provider) and goes directly to the end user network and network elements. As discussed hereinabove, one application for providing such bypass flows of over-the-top content can involve using a last-hop router to transmit over-the-top content received from an IP content source directly to the system EQAM, bypassing the system CMTS. The last-hop router can be configured to provide a bypass tunnel directly to the EQAM, thus bypassing the CMTS. Bypass encapsulation of the IP content identified for bypass data flow can be performed in a suitable manner by an appropriate system bypass encapsulation device or component.

For example, the last-hop router can be configured to perform the bypass encapsulation of the over-the-top content identified for bypass flow. Alternatively, the last-hop router can transmit the content identified for bypass flow to an EQAM that is configured to perform bypass encapsulation, and the EQAM performs the bypass encapsulation of the identified over-the-top content. In this manner, over-the-top content from an IP content source is transmitted to the last-hop router, which passes the content directly to the EQAM, bypassing the CMTS. The necessary bypass encapsulation is performed by the last-hop router and/or the EQAM. The bypass encapsulated content is transmitted from the EQAM to the end user network elements as a DOCSIS flow.

However, as discussed hereinabove, such system needs to be able to properly identify which portions of the over-the-top content are to receive bypass encapsulation. Also, it would be advantageous to also determine and provide appropriate Quality of Service (QoS) settings for the over-the-top content identified for bypass encapsulation. For example, MSOs may make arrangements with IP content providers to apply bypass encapsulation only to certain portions of IP content. Accordingly, the portions of IP content selected or designated for bypass encapsulation need to be properly identified, and their corresponding QoS settings readily available.

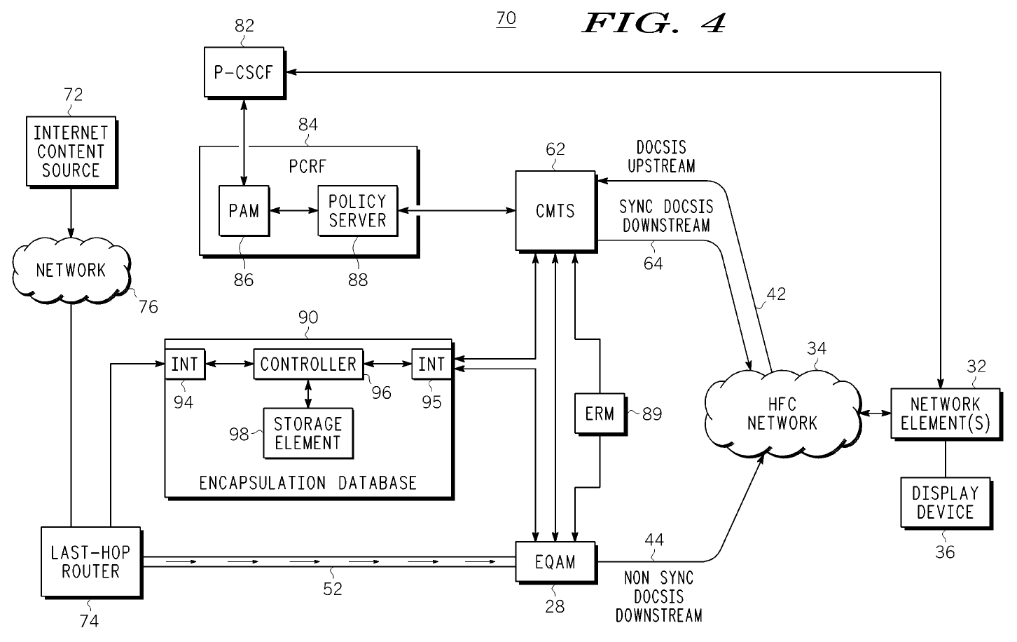

Referring now to FIG. 4, shown is a block diagram of an IP content delivery system according to the PacketCable Multimedia (PCMM) architecture specifications, including a bypass architecture for over-the-top content, and including an encapsulation database, such as a DIBA Encapsulation Database. The PCMM specifications define a framework for providing QoS, security and resource allocation and management for any type of service within a DOCSIS network.

The IP content delivery system 70 includes one or more IP content sources 72 of over-the-top content or IP content. The system 70 also includes one or more last-hop routers 74 coupled between the IP content source 72 and the EQAM 28. The last-hop router 74 is coupled to the IP content source 72 is any suitable manner, e.g., via one or more networks 76, such as a regional area network or a local network. As will be discussed in greater detail hereinbelow, the last-hop router 74 is coupled to the EQAM 28 using one or more suitable connections 52, such as one or more “tunnel” or “pseudo-wire” (DEPI) connections. Alternatively, the last-hop router 74 can be coupled to the CMTS 62, for transmission of content that is not to bypass the CMTS 62. The display device 36 and/or the network element 32 are able to communicate with and select content from various IP content sources 72. These communications are carried out via IP packets traveling between the network element 32 and the IP content sources 72, over the usual path of the cable modem portion of the network element 32, the HFC network 34, the upstream DOCSIS data channel 42 and the downstream DOCSIS data channel 64, the CMTS 62, the last hop router 74, and the network 76.

The PCMM framework includes a Proxy Call Session Control Function (P-CSCF) 82. In general, the P-CSCF 82 is responsible for reserving, committing and releasing Quality of Service (QoS) resources for a given IP content flow session over the CMTS 62 and the EQAMs 28. Messages between the P-CSCF 82 and the last-hop router 74 are exchanged using an appropriate protocol, e.g., the session initiation protocol (SIP), and using an appropriate interface therebetween, such as a Gm interface.

The PCMM framework also includes a Policy and Charging Rules Function (PCRF) 84 coupled between the P-CSCF 82 and the CMTS 62. The PCRF 84 includes a PacketCable Application Manager (PAM) 86 coupled to the P-CSCF 82 and a Policy Server 88 coupled between the PAM 86 and the CMTS 62. The PAM 86 is a specialized application manager primarily responsible for determining the QoS resources needed for a session, based on the received session descriptors from the P-CSCF 82, and managing the QoS resources allocated for the session. The Policy Server 88 generally is a system that primarily acts as an intermediary between the PAM 86 and the CMTS 62. The Policy Server 88 applies network policies to requests by the PAM 86 and proxies messages between the PAM 86 and the CMTS 62.

The session-based policy set-up information exchanged between the P-CSCF 82 and the PAM 86 occurs using an appropriate protocol, e.g., the Diameter protocol, and using an appropriate interface therebetween, such as an Rx interface. The requests, messages and other information exchanged between the PAM 86 and the Policy Server 88 occurs using an appropriate protocol, e.g., the Common Open Policy Service (COPS) protocol. Also, the messages and information exchanged between the Policy Server 88 and the CMTS 62 occurs using an appropriate protocol, such as the COPS protocol.

An edge resource manager (ERM) 89 is shown coupled between the CMTS 62 and the EQAM 28. In general, the ERM 89 allocates and manages the resources of the edge devices, e.g., the one or more EQAMs 28. The ERM 89 also communicates with and receives instructions from a session manager (not shown), which may be located in the CMTS 62 or, alternatively, may be located in the PAM 86. The information exchanged between the CMTS 62 and the ERM 89, or between the ERM 89 and the EQAM 28, occurs according to the DOCSIS specification, e.g., using the Real Time Streaming Protocol (RTSP).

The IP content delivery system 70 also includes an encapsulation database 90, such as a DIBA Encapsulation Database. The encapsulation database 90 can reside partially or completely at any suitable location within the IP content delivery system 70. The encapsulation database 90 typically is operably coupled between the last-hop router 74 and the CMTS 62. The operable interaction between the last-hop router 74 and the encapsulation database 90 and the interaction between the CMTS 62 and the encapsulation database 90 will be discussed in greater detail hereinbelow.

It should be understood that some of the components in the system 70 typically are located within the same local network and therefore can be configured to pass control messages, for purposes of configuration and control, or otherwise communicate with one another over a control plane across the particular local network. For example, the last-hop router 74, the EQAM 28 and the CMTS 62 typically are located within the same local network and therefore can communicate with one another over the local network, such as by passing configuration and control messages therebetween. Also, the encapsulation database 90 can be located within the same local network as one or more of the last-hop router 74 and the CMTS 62, although such is not necessary.

The encapsulation database 90 can be any suitable standalone component or apparatus within an existing system component that receives, stores, organizes and makes available appropriate encapsulation identification information, which can include information that identifies the portions of IP content that are to receive bypass encapsulation, as well as QoS settings and/or other appropriate information for those portions of IP content selected or identified to receive bypass encapsulation.

The encapsulation database 90 includes a first interface 94, a second interface 95, a controller 96 coupled between the first and second interfaces 94, 95, and a data storage element 98 coupled to the controller 96. The controller 96 generally processes encapsulation identification information and other information received by the encapsulation database 90. The controller 96 also manages the movement of encapsulation identification information and other information to and from the data storage element 98, and to and from the encapsulation database 90. In addition to the content storage element 98, the encapsulation database 90 can include at least one type of memory or memory unit (not shown) within the controller 96 and/or a storage unit or data storage unit coupled to the controller 96 for storing processing instructions and/or information received and/or created by the encapsulation database 90.

The first interface 94 is configured to transmit and receive encapsulation identification information (and other information) to and from other components within the system 70, e.g., the IP content source 72 and the last-hop router 74. The second interface 95 also is configured to transmit and receive encapsulation identification information (and other information) to and from other components within the system 70, e.g., the CMTS 62 and/or the EQAM 28. It should be understood that the interfaces 94, 95 can be a single input/output interface coupled to the controller 96. Also, it should be understood that one or more of the interfaces 94, 95 can be an interface configured to support more than one connection from more than one system component or device. The input and/or output interfaces 94, 95 are configured to provide any protocol interworking between the other components within the encapsulation database 90 and the other components within the system 70 that are external to the encapsulation database 90. Because all content distribution systems are not the same, the interfaces 94, 95 are configured to support the protocols of the particular system that is providing the content. Such protocol support functionality includes the identification of the content streams and corresponding protocol support required by the distribution system. Each distribution system typically will use a defined set of protocols.

One or more of the controller 96, the storage element 98 and the interfaces 94, 95 can be comprised partially or completely of any suitable structure or arrangement, e.g., one or more integrated circuits. Also, it should be understood that the encapsulation database 90 includes other components, hardware and software (not shown) that are used for the operation of other features and functions of the encapsulation database 90 not specifically described herein. Moreover, the encapsulation database 90 can be partially or completely configured in the form of hardware circuitry and/or other hardware components within a larger device or group of components. Alternatively, the encapsulation database 90 can be partially or completely configured in the form of software, e.g., as processing instructions and/or one or more sets of logic or computer code. In such configuration, the logic or processing instructions typically are stored in a data storage device, e.g., the content storage element 98 or other suitable data storage device. The data storage device typically is coupled to a processor or controller, e.g., the controller 96. The controller accesses the necessary instructions from the data storage element and executes the instructions or transfers the instructions to the appropriate location within the encapsulation database 90.

The last-hop router 74 can be configured to apply or perform appropriate bypass encapsulation of IP content identified for bypass encapsulation, and to transmit the bypass encapsulated IP content directly to the EQAM 28, bypassing the CMTS 62. The IP content emerges from the EQAM 28 as a DOCSIS flow, e.g., a downstream DOCSIS RF signal from the point of view of the network elements 32. In such arrangement, the last-hop router 74 is configured to communicate with appropriate components within the system 70, e.g., the encapsulation database 90, the CMTS 62, the packet cable multimedia QoS mechanism (e.g., the Proxy CSCF 82) and other elements of the DOCSIS bypass control plane, e.g., one or more elements containing bypass encapsulation information.

In this manner, the last-hop router 74 can be signaled when to apply the bypass encapsulation and when to bypass to a new IP content flow. Then, the last-hop router 74 can access and obtain appropriate bypass encapsulation information from any appropriate component within the system 70 that contains the appropriate bypass encapsulation information. Such information can include the 5-tuple with which to identify the packets of that new video flow, such as the Source and Destination IP addresses, the Source and Destination Layer 4 port numbers, and the IP protocol type. The last-hop router 74 also can obtain other bypass encapsulation fields for the new data flow, such as the hardware address for the network element 32 to which the IP content is destined, and the IP address of the EQAM 28 to which to send the bypass encapsulated IP content. Also, the last-hop router 74 can obtain encapsulation identification information from the encapsulation database 90. With such bypass encapsulation information, the last-hop router 74 is able to perform the bypass encapsulation of the appropriate IP content, and then transmit the encapsulated IP content directly to the appropriate EQAM 28, e.g., via an appropriate tunnel, such as a DEPI tunnel.

Also, alternatively, the EQAM 28 can be configured to apply or perform bypass encapsulation on the IP content identified for bypass encapsulation. The last-hop router 74 identifies the IP content for bypass encapsulation by accessing or obtaining the appropriate bypass encapsulation information, including appropriate encapsulation identification information from the encapsulation database 90. The last hop router 74 also sets up a tunnel to the appropriate EQAM 28, and transmits the IP content for a given bypass flow to the EQAM 28 via this tunnel. In this case, the tunnel typically is an IP over IP type tunnel, such as a Generic Routing Encapsulation (GRE) tunnel.

The EQAM 28 then applies or performs the actual bypass encapsulation. For example, the EQAM 28 accesses or obtains bypass encapsulation fields and other bypass encapsulation information from an appropriate database or other component within the system, e.g., the same components used by the last-hop router 74 to access or obtain bypass encapsulation information. For example, the EQAM 28 downloads the DOCSIS MAC Header field, the DOCSIS MAC Extended Header field and other appropriate fields for performing the bypass encapsulation. The EQAM 28 also downloads the necessary QoS fields for the given DOCSIS data flow. Such QoS information can be accessed or obtained from the ERM 89 or other appropriate component within the system 70. With the appropriate bypass encapsulation information, the EQAM 28 is able to perform the bypass encapsulation and provide the correct QoS levels for that flow. The EQAM 28 then transmits the bypass encapsulated IP content as a DOCSIS flow, e.g., a downstream DOCSIS RF signal, to the network elements 32.

Using this arrangement, an MSO can identify and provide DIBA encapsulation, delivery and Quality of Service to over-the-top content or other IP content from the Internet. The MSO can use relatively standard last hop routers and modified EQAMs. Because EQAMs intrinsically are cable devices, their configurations lend themselves to modification for bypass encapsulation.

The use of the encapsulation database 90 allows an MSO to provide DIBA service, i.e., CMTS bypass and QoS provisioning, to selected portions of IP content received from the IP content providers. The MSOs generally are able to establish arrangements with IP content providers to provide special QoS for IP content from these providers. Depending on the particular arrangements, the QoS for the IP content can be better or worse than usual. Those IP content providers who have made such arrangements with an MSO will have their IP content identified in the encapsulation database 90 for bypass encapsulation. Those IP content providers who do not have such arrangements with the MSO will not have their IP content identified in the encapsulation database 90, and their IP content will be transmitted through the IP content delivery system 70 as best effort traffic. The MSO typically controls the encapsulation database 90 and inputs information into the encapsulation database 90 as the MSO makes QoS arrangements with IP content providers. The encapsulation database 90 also can be used by an MSO to control which portions of IP content from their own servers is to receive bypass encapsulation.

The encapsulation database 90 can be configured in any suitable manner. For example, the information received by and stored in the encapsulation database 90 can be organized and searchable based on any suitable identifiable feature of the information, such as the Uniform Resource Locator (URL) of the IP content or a domain name within the URL. A network element that activates QoS, such as a Proxy-Call Session Control Function, will receive a request for QoS for a particular IP content URL. This network element will search the encapsulation database 90 for the requested IP content URL, and retrieve appropriate encapsulation identification information on the QoS to be provided for this IP content URL. The network element then will activate the Packet Cable Multimedia mechanism to secure QoS for the IP content flow. The CMTS 62 will establish the necessary QoS-enhanced service flow to the cable modem.

With regard to QoS settings, such as reserved bandwidth and maximum bandwidth, the encapsulation database 90 also can be configured so that the information received by and stored in the encapsulation database 90 can be searchable by an element of the QoS provisioning system in the cable network. For example, one searchable element is the Proxy-Call Session Control Function (P-CSCF) that is part of the Packet Cable 2.0 system. When an SIP-enabled IPTV client sends an SIP invite to the P-CSCF 82 for a particular IP content URL, the P-CSCF 82 will, in turn, search the encapsulation database 90. If it turns out that this particular IP content is designated to have a particular QoS setting, then the P-CSCF 82 will continue to carry out the Packet Cable QoS setting mechanism for that IP content. Alternatively, for non-SIP based systems, the client communicates directly to the PAM 86, which, in turn, requests the QoS for the requested content flow from the rest of the PCMM system.

The specific data flows associated with the IP content bypass encapsulation as described hereinabove, including the role of the encapsulation database 90, now will be described. The data flows are described for an IP content delivery system in which encapsulation database 90 includes encapsulation identification information and the last-hop router performs the bypass encapsulation.

First, the end user client or IP content client, which is assumed to be or include an SIP-enabled browser provided by the MSO, selects desired IP content from a web site, e.g., by “clicking” or otherwise obtaining the Uniform Resource Locator (URL) of the IP content. In response, the browser sends an SIP INVITE command to the P-CSCF 82 to set up a new bypass flow. The SIP INVITE command includes various information about the IP content and the desired end user transaction, including the URL of the selected IP content and the IP address and Layer 3 port of the destination end user (customer) premises equipment (CPE). At this stage, typically, it is not yet known if there is a QoS agreement between the IP content provider and the MSO.

The P-CSCF 82 searches the encapsulation database 90 for the URL of the selected IP content to see if there is a QoS agreement between the MSO and the provider of the selected IP content. If there is a QoS agreement, the P-CSCF 82 will locate the associated QoS settings in the encapsulation database 90. The P-CSCF 82 also will locate in the encapsulation database 90 the IP address of the IP content provider associated with the URL of the selected IP content. Alternatively, such IP address could be made available from the Internet. Also, alternatively, if the IP address is cached locally, the P-CSCF 82 can access the IP address information locally. The P-CSCF 82 also obtains from the encapsulation database 90 the Layer 4 port of the source of the selected IP content.

The P-CSCF 82 activates the QoS mechanism using the PAM 86. Then, using the Policy Server 88, the PCMM communicates with the CMTS 62 (via COPs) to set up the gate for the IP content data flow. In response, the CMTS 62 requests DOCSIS bandwidth via the ERM 89 and an EQAM 28. The CMTS 62 obtains the necessary bandwidth on an available EQAM 28. The CMTS 62 then sets up a DOCSIS DEPI tunnel from the CMTS 62 to the particular EQAM 28. In the case where the last hop router 74 is generating a DOCSIS Packet Streaming Protocol (PSP) flow to the EQAM 28, this tunnel is needed to pass certain DOCSIS MAC management information to the EQAM 28, such as Mac Domain Descriptors (MDDs). MDDs are needed for the downstream DOCSIS channel 44 from the EQAM 28 to the cable modem portion of the network element 32, and are generally generated by the CMTS 62.

The CMTS 62 then sets up the IP content data flow to the network elements 32 (e.g., a cable modem) of the end user client who selected the particular IP content. As part of this data flow setup, various information is exchanged between the CMTS 62 and the end user network elements 32, such as a Service Flow ID, QoS settings, and the downstream DOCSIS carrier frequency. Also, the CMTS 62 issues a request for a Dynamic Service Addition and a request for a Downstream Bonding Channel.

The CMTS 62 makes available necessary DOCSIS bypass headers and other bypass information for use by other components in the system 70, such as the last-hop router 74, later in the process. For example, the CMTS 62 can enter certain data fields into the encapsulation database 90, which is accessible by the last-hop router 74 or other component that will perform bypass encapsulation. Such information can include the Source Port, the IP Destination Port, the CPE MAC address, the PSP Flow ID, the PSP Initial Sequence Number, the EQAM IP address and the EQAM port number. The CMTS 62 then signals back to the P-CSCF 82, via the PCMM, of a successful QoS setup.

Upon successful QoS setup, the last hop router 74 obtains the necessary bypass encapsulation header information provided by the CMTS 62, e.g., from the encapsulation database 90. For example, the P-CSCF 82 can issue an SIP invite command to the last hop router 74. Once the last-hop router 74 has obtained the bypass packet inspection information and encapsulation information, the last-hop router 74 issues an SIP OK message back to the P-CSCF 82. In response, the P-CSCF 82 issues an SIP OK message to the IP content client. The IP content client then can initiate data flow of the selected IP content (e.g., using an HTTP GET command) from the IP content source (or from a local cache if the IP content previously was stored locally). In this manner, the IP content data flow begins from the IP content source 72 to the last-hop router 74.

Upon receiving the IP content from the IP content source, the last-hop router 74 performs bypass encapsulation on the received IP content. The last-hop router 74 then transmits the bypass encapsulated IP content directly (via DEPI tunnel) to the EQAM 28, bypassing the CMTS 62. The IP content flow transmitted to the EQAM 28 then is transmitted over the non-primary downstream DOCSIS channel 44 to the network elements 32 and the IP content client, e.g., in a conventional manner. Alternatively, the last-hop router will bypass the IP-video packets to the EdgeQAM or intermediary device for encapsulation.

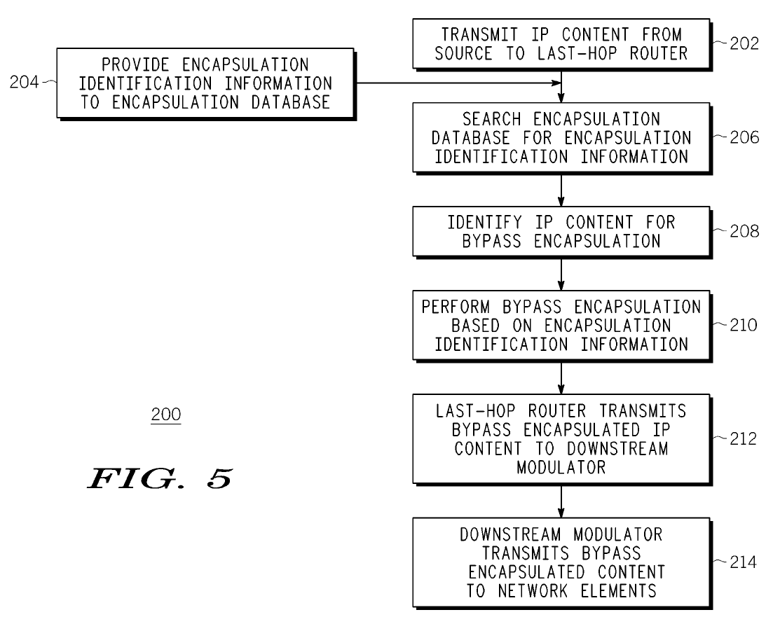

Referring now to FIG. 5, with continuing reference to FIG. 4, shown is a flow chart that schematically illustrates a method for delivering IP content within a system that includes a bypass architecture for over-the-top content, and includes an encapsulation database, such as a DIBA Encapsulation Database. The method 200 includes a step 202 of transmitting IP content from the IP content source 72 to the last-hop router 74, e.g., via the network 76. The IP content can be transmitted from an Internet source or from a locally-cached IP content source. The transmission of IP content typically is in response to a request from an end user (e.g., via customer premises equipment) to the P-CSCF 82 for SIP-based video content and/or to the PAM 86 for non-SIP based video content.

The method also includes a step 204 of providing encapsulation identification information to the encapsulation database 90. As discussed hereinabove, the IP content source 72, via the last-hop router 74, can provide appropriate encapsulation identification information to the encapsulation database 90, e.g., under the control of the MSO. Also, the CMTS 62, the P-CSCF 82, and/or any other suitable component within the IP content delivery system 70 can provide encapsulation identification information to the encapsulation database 90, as appropriate.

The method also includes a step 206 of searching the encapsulation database 90 for encapsulation identification information. For example, as discussed hereinabove, in response to receiving an SIP INVITE command to set up a new bypass flow, the P-CSCF 82 searches the encapsulation database 90 for the URL of the selected IP content to see if there is a QoS agreement between the MSO and the provider of the selected IP content. Also, the P-CSCF 82 will search the encapsulation database 90 and locate the associated QoS settings if there is a QoS agreement. The P-CSCF 82 also can search the encapsulation database 90 and locate the IP address of the IP content provider associated with the URL of the selected IP content.

The method also includes a step 208 of identifying the portions of the IP content selected for bypass encapsulation, based on encapsulation identification information accessed from the encapsulation database 90. As discussed hereinabove, the IP content delivery system 70 includes a last-hop router 74 that can be configured to perform bypass encapsulation. Once the IP content to be bypass encapsulated is identified, e.g., using encapsulation identification information accessed from the encapsulation database 90, the last-hop router 74 or other appropriate component within the IP content delivery system 70 can perform a bypass encapsulation step 210 on such IP content.

For example, as discussed hereinabove, upon appropriate instructions from the PCMM framework (upon activation from the P-CSCF 82), the CMTS 62 can provide the appropriate DIBA headers and other appropriate encapsulation identification information to the encapsulation database 90 for retrieval by the last-hop router 74 (or other appropriate bypass encapsulation component). Using the retrieved encapsulation identification information, the last-hop router 74 is able to perform the bypass encapsulation step 210 on the IP content identified suitably by the encapsulation identification information. The last-hop router 74 then transmits the bypass encapsulated IP content directly to the EQAM 28, bypassing the CMTS 62. In such arrangement, the method 200 includes a step 212 of the last-hop router 74 transmitting bypass encapsulated IP content to the EQAM 28.

The method 200 also includes a step 214 of the EQAM 28 transmitting bypass encapsulated IP content to the network elements 32 of the end user IP client. The EQAM 28 is configured to send the bypass encapsulated IP content to the network elements 32 via the downstream DOCSIS channel 44.

Alternatively, the IP content delivery system 70 can be configured in such a way that at least a portion of the encapsulation is performed by the EQAM 28. In such configuration, the bypass encapsulation step 210 is performed at least partially by the EQAM 28. Accordingly, the transmission step 212 may transmit IP content that is only partially bypass encapsulated or has yet to be bypass encapsulated.

The method shown in FIG. 5 may be implemented in a general, multi-purpose or single purpose processor. Such a processor will execute instructions, either at the assembly, compiled or machine-level, to perform that process. Those instructions can be written by one of ordinary skill in the art following the description of FIG. 5 and stored or transmitted on a computer readable medium. The instructions may also be created using source code or any other known computer-aided design tool. A computer readable medium may be any medium capable of carrying those instructions and includes random access memory (RAM), dynamic RAM (DRAM), flash memory, read-only memory (ROM), compact disk ROM (CD-ROM), digital video disks (DVDs), magnetic disks or tapes, optical disks or other disks, silicon memory (e.g., removable, non-removable, volatile or non-volatile), packetized or non-packetized wireline or wireless transmission signals.

It will be apparent to those skilled in the art that many changes and substitutions can be made to the bypass architecture devices, methods and systems herein described without departing from the spirit and scope of the invention as defined by the appended claims and their full scope of equivalents.

1. An encapsulation database apparatus for use in a system for transmitting internet protocol (IP) content from at least one IP content source to a downstream modulator and having a bypass architecture, wherein the system includes a last-hop router coupled between the IP content source and the downstream modulator and a cable modem termination system (CMTS) coupled to the downstream modulator, and wherein the downstream modulator is configured to transmit IP content to at least one end user network element coupled to the downstream modulator, the apparatus comprising:
a first interface for coupling the encapsulation database apparatus to the last-hop router;
a controller coupled to the first interface;
a data storage element coupled to the controller for storing therein encapsulation identification information received by the encapsulation database apparatus; and
a second interface coupled to the controller and for coupling the encapsulation database apparatus to at least one of the cable modem termination system and the downstream modulator,
wherein the controller is configured to receive encapsulation identification information from at least one of the IP content source, the cable modem termination system and a PacketCable Application Manager coupled to the cable modem termination system,
wherein the controller is configured to provide encapsulation identification information to at least one component within the system coupled to the encapsulation database apparatus, wherein the encapsulation identification information is used to transmit IP content from the at least one IP content source to the downstream modulator in such a way that the transmitted IP content bypasses the cable modem termination system.

2. The apparatus as recited in claim 1, wherein the encapsulation identification information includes information that identifies which portions of the IP content are to be transmitted from the at least one IP content source to the downstream modulator in such a way that the transmitted IP content bypasses the cable modem termination system.

3. The apparatus as recited in claim 1, wherein the encapsulation identification information includes Quality of Service (QoS) settings for at least one portion of the IP content that is to be transmitted from the at least one IP content source to the downstream modulator in such a way that the transmitted IP content bypasses the cable modem termination system.

4. The apparatus as recited in claim 1, wherein the encapsulation database apparatus is configured in such a way that the encapsulation identification information stored therein is searchable by at least one component within the system coupled to the encapsulation database apparatus.

5. The apparatus as recited in claim 4, wherein the encapsulation identification information stored in the encapsulation database apparatus is searchable by at least one of a Uniform Resource Locator (URL) of the IP content or a domain name within the Uniform Resource Locator (URL) of the IP content.

6. The apparatus as recited in claim 1, wherein at least one of the last-hop router, the cable modem termination system and the PacketCable Application Manager provides at least a portion of the encapsulation identification information to the encapsulation database.

7. The apparatus as recited in claim 1, wherein the last-hop router provides a bypass communication channel between the last-hop router and the downstream modulator for transmission of IP content from the at least one IP content source to the downstream modulator in such a way that the transmitted IP content bypasses the cable modem termination system.

8. The apparatus as recited in claim 1, wherein the downstream modulator further comprises an Edge Quadrature Amplitude Modulation (EQAM) modulator.

9. The apparatus as recited in claim 1, wherein at least one IP content source includes at least one of a video on demand (VOD) server, an IPTV broadcast video server, and an Internet video source.

10. A method for transmitting internet protocol (IP) content from at least one IP content source to a downstream modulator within an IP content delivery system having a bypass architecture, wherein the IP content delivery system includes a last-hop router coupled between the IP content source and the downstream modulator and a cable modem termination system (CMTS) coupled to the downstream modulator, and wherein the downstream modulator is configured to transmit IP content to at least one end user network element coupled to the downstream modulator, the method comprising the steps of:
receiving IP content transmitted from the at least one IP content source;
accessing encapsulation identification information from an encapsulation database apparatus to determine which portions of the IP content are to be receive bypass encapsulation;
performing bypass encapsulation on at least a portion of the received IP content based on the accessed encapsulation identification information; and
transmitting bypass encapsulated IP content to the at least one end user network element,
wherein bypass encapsulation is performed on the received IP content in such a way that the bypass encapsulated IP content can be transmitted to the at least one end user network element via the downstream modulator in such a way that the bypass encapsulated IP content bypasses the cable modem termination system.

11. The method as recited in claim 10, wherein the encapsulation identification information includes information that identifies which portions of the IP content are to be transmitted from the at least one IP content source to the downstream modulator in such a way that the transmitted IP content bypasses the cable modem termination system.

12. The method as recited in claim 10, wherein the encapsulation identification information includes Quality of Service (QoS) settings for at least one portion of IP content that is to be transmitted from the at least one IP content source to the downstream modulator in such a way that the transmitted IP content bypasses the cable modem termination system.

13. The method as recited in claim 10, wherein the accessing step includes searching the encapsulation database apparatus by at least one component within the IP content delivery system coupled to the encapsulation database apparatus.

14. The method as recited in claim 10, wherein the accessing step includes searching the encapsulation database apparatus by at least one of a Uniform Resource Locator (URL) of the IP content or a domain name within the Uniform Resource Locator (URL) of the IP content.

15. The method as recited in claim 10, further comprising the step of providing encapsulation identification information to the encapsulation database apparatus by at least one of the last-hop router, the cable modem termination system and a PacketCable Application Manager coupled to the cable modem termination system.

16. The method as recited in claim 10, wherein the last-hop router accesses encapsulation identification information from the encapsulation database apparatus.

17. The method as recited in claim 10, further comprising the step of the last-hop router providing a bypass communication channel between the last-hop router and the downstream modulator for transmission of the bypass encapsulated IP content from the last-hop router to the downstream modulator.

18. A computer readable medium storing instructions that, when executed on a programmed processor, carry out a method for transmitting internet protocol (IP) content from at least one IP content source to a downstream modulator within an IP content delivery system having a bypass architecture, wherein the system includes a last-hop router coupled between the IP content source and the downstream modulator and a cable modem termination system (CMTS) coupled to the downstream modulator, and wherein the downstream modulator is configured to transmit IP content to at least one end user network element coupled to the downstream modulator, the computer readable medium comprising:
instructions for receiving IP content transmitted from the at least one IP content source;
instructions for accessing encapsulation identification information from an encapsulation database apparatus to determine which portions of the IP content are to be receive bypass encapsulation;
instructions for performing bypass encapsulation on at least a portion of the received IP content based on the accessed encapsulation identification information; and
instructions for transmitting bypass encapsulated IP content to the at least one end user network element,
wherein bypass encapsulation is performed on the received IP content in such a way that the bypass encapsulated IP content can be transmitted to the at least one end user network element via the downstream modulator in such a way that the bypass encapsulated IP content bypasses the cable modem termination system.

19. The computer readable medium as recited in claim 18, wherein the encapsulation identification information includes at least one of information that identifies which portions of IP content are to receive bypass encapsulation and Quality of Service (QoS) settings for portions of IP content selected to receive bypass encapsulation.

20. The computer readable medium as recited in claim 18, further comprising instructions for searching the encapsulation database apparatus by a Uniform Resource Locator (URL) of the IP content.
